(19) United States
(12) Patent Application Publication
(10) Pub. No.: US 2009/0260340 A1
(43) Pub. Date: Oct. 22, 2009

(54) Combustor of a Turbine, a Method of Retro-Fitting a Combustor of a Turbine and a Method of Building a Combustor of a Turbine

(75) Inventors: William Hessler, Greer, SC (US); Predrag Popovic, Greenville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/104,952

(22) Filed: Apr. 17, 2008

(51) Int. Cl. F23R 3/26; F02C 1/00; B21D 53/00

(52) U.S. Cl. 60/39.23; 60/751; 29/890.01

(57) ABSTRACT

A combustor of a turbine, a method of retro-fitting a combustor of a turbine and a method of building a combustor of a turbine are each provided. The combustor includes a combustion chamber along which a dilution breach is defined, a casing perimetrically surrounding the combustion chamber so as to define an airflow between the casing and the combustion chamber, the airflow being configured to supply dilution air to the combustion chamber via the dilution breach, and an easy to adjust dilution airflow tuning part disposed on the casing and in communication with the airflow. The dilution airflow tuning part is configured to increase and/or decrease an available amount of the dilution air to be supplied to the combustion chamber.

### BACKGROUND

Aspects of the present invention are directed to a combustor of a turbine, a method of retro-fitting a combustor of a turbine and a method of building a combustor of a turbine and, more particularly, to a combustor of a turbine including a dilution air tuning pall, a method of retro-fitting a combustor of a turbine with a dilution air tuning part and a method of building a combustor of a turbine with a dilution air tuning part.

As changes are required for tuning, inefficiencies in the installation of and/or repair of gas turbine engines have been observed. That is, it is understood that maintaining a certain amount of dilution air in a combustion chamber of a gas turbine engine is necessary for the efficient operation and tuning of the gas turbine engine. It is further understood that maintenance of such amounts of the dilution air can be accomplished by increasing or decreasing a size of a dilution breach in a liner of the combustion chamber. The processes associated with increasing or decreasing the size of the dilution breach, however, are time consuming and costly and may need to be repeated several times in order to achieve a desired result as is required now to tune the combustor.

For example, if a gas turbine is found to be operating inefficiently because the dilution breach needs to be widened, at least the casing of the entire gas turbine may need to be removed. This could involve shutting down a combustor, disassembling a cap assembly, end-covers, fuel lines and liners and removing 20 bolts from each flange of the casing. Once the liner is removed, the dilution breach can be widened, and the assembly can be rebuilt. At that point, if the gas turbine engine is still found to be operating inefficiently, the process may need to be repeated.

### BRIEF DESCRIPTION OF THE INVENTION

In accordance with an aspect of the invention, a combustor of a turbine is provided and includes a combustion chamber, in which fuel combustion occurs and along which a dilution breach is defined, a casing perimetrically surrounding the combustion chamber so as to define an airflow between the casing and the combustion chamber, the airflow being configured to supply dilution air to the combustion chamber via the dilution breach, and a dilution airflow tuning part disposed on the casing and in communication with the airflow, the dilution airflow tuning part being configured to increase and/or decrease an available amount of the dilution air to be supplied to the combustion chamber.

In accordance with another aspect of the invention, a method of retro-fitting a combustor of a turbine is provided. The turbine includes a fuel combustion chamber, and a casing perimetrically surrounding the combustion chamber and defining an airflow from which dilution air is supplied to the combustion chamber via a dilution breach. The method includes measuring a fuel combustion characteristic, determining that an available amount of the dilution air to be supplied to the combustion chamber is below a predetermined threshold based on the measured fuel combustion characteristic, and installing a dilution airflow tuning part onto the casing and in communication with the airflow so as to increase and/or decrease an available amount of the dilution air to be supplied to the combustion chamber.

In accordance with another aspect of the invention, a method of building a combustor of a turbine is provided and includes forming a fuel combustion chamber, forming a dilution breach along an exterior of the combustion chamber, perimetrically surrounding the combustion chamber with a casing to define an airflow between the casing and the combustion chamber, the airflow being configured to supply dilution air to the combustion chamber via the dilution breach, and installing a dilution airflow tuning part onto the casing and in communication with the airflow to thereby be positioned to increase and/or decrease an available amount of the dilution air to be supplied to the combustion chamber.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a partial cross-sectional view of an exemplary gas turbine engine;

FIGS. 2A and 2B are perspective views of a dilution air-tulle device that is similar in shape to a spark plug and a dilution air-tune device that is similar in shape to a cross-fire tube, respectively, in accordance with exemplary embodiments of the invention;

FIG. 3 is a perspective view of a dilution air tuning component in accordance with an exemplary embodiment of the invention; and

FIG. 4 is a schematic diagram of a controller and servo mechanism for use with the exemplary gas turbine engine of FIG. 1.

### DETAILED DESCRIPTION OF THE INVENTION

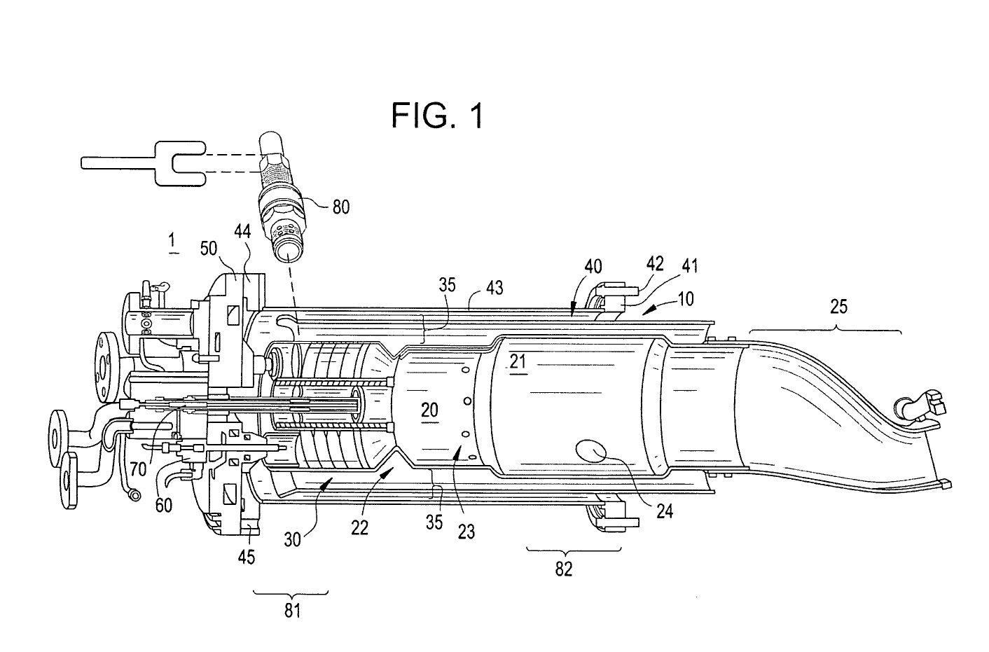

With reference to FIG. 1, an exemplary gas turbine engine 1 includes a compressor (not shown), a combustor 10 and a turbine (not shown) downstream from the combustor 10. The combustor 10 includes a combustion chamber 20, in which combustion of air and fuel occurs, a transition duct 25 that extends downstream from the combustion chamber 20 and a casing 40 that encases the combustion chamber 10.

The combustion chamber 20 includes an annular combustion liner 21. A venturi throat region 22 is defined along the combustion liner 21 and includes a converging portion in which the combustion liner 21 narrows and a diverging portion, disposed downstream from the converging portion, in which the combustion liner 21 widens. Exhaust ports 23 are defined along the combustion liner 21 to allow for cooling and to aid in combustion traveling into the combustion chamber 20. A dilution breach 24 is defined in the combustion liner 21 at a second axial position 82 of the combustion chamber 20. The dilution breach 24 allows dilution air to enter into the combustion chamber 20 and, when a size of the dilution breach 24 is calibrated for the gas turbine engine 1, is configured to maintain an appropriate level of dilution air for combustion within the combustion chamber 20.

The combustion chamber 20 is surrounded by the casing 40 such that an annular airflow 35 is defined around an exterior of the combustion chamber 20. A flow sleeve 30 is coupled to an interior surface of the casing 40 and guides airflows within the airflow 35 from a distal end of the casing 40 to, at least, the dilution breach 24.

The casing 40 includes a first flange 41, which is supported by first bolts 42, outer casing 43, which is coupled to the first flange 41, and second flange 44, which is coupled to the outer casing 43 and which is supported by second bolts that are received in bolt receiving spaces 45. A cap assembly 50, including a primary fuel nozzle 60 and a secondary fuel nozzle 70, is disposed at an end portion of the casing 40 and is coupled to the second flange 44 by, at least, the second bolts.

Since, the first bolts 42 and the second bolts are each provided in sets of about twenty (20) bolts, processes of assembling and disassembling the casing 40 are each time consuming. That is, an assembling of the casing 40 includes positioning the first flange 41, the outer casing 43, the second flange 44 and the cap assembly 50 and tightening about forty (40) bolts while a disassembling of the casing 40 requires, at least, the removal of the forty (40) bolts. As such, reducing a number of times the assembling and disassembling processes need to be performed to, e.g., re-calibrate the size of the dilution breach 24, may be advantageous.

To this end, a dilution airflow tuning part 80 is disposed on the casing 40 and in communication with the airflow 35. The dilution airflow tuning part 80 is configured to increase and/or decrease all available amount of the dilution air to be supplied to the combustion chamber 20 and, therefore, substantially reduces or nullifies a need to repeatedly disassemble so as to re-calibrate the dilution breach 24, which would otherwise require the repeated assembling/disassembling of, at least, the casing 40.

According to an embodiment of the invention, the dilution airflow tuning part 80 is located at a first axial position 81 of the combustor 10. Here, the first axial position 81 is forward along the longitudinal axis of the gas turbine engine 1 from the second axial position 82 where the dilution breach 24 is disposed. In further detail, it is noted that the first axial position 81 may be proximate to the cap assembly 50 but is not limited to this location.

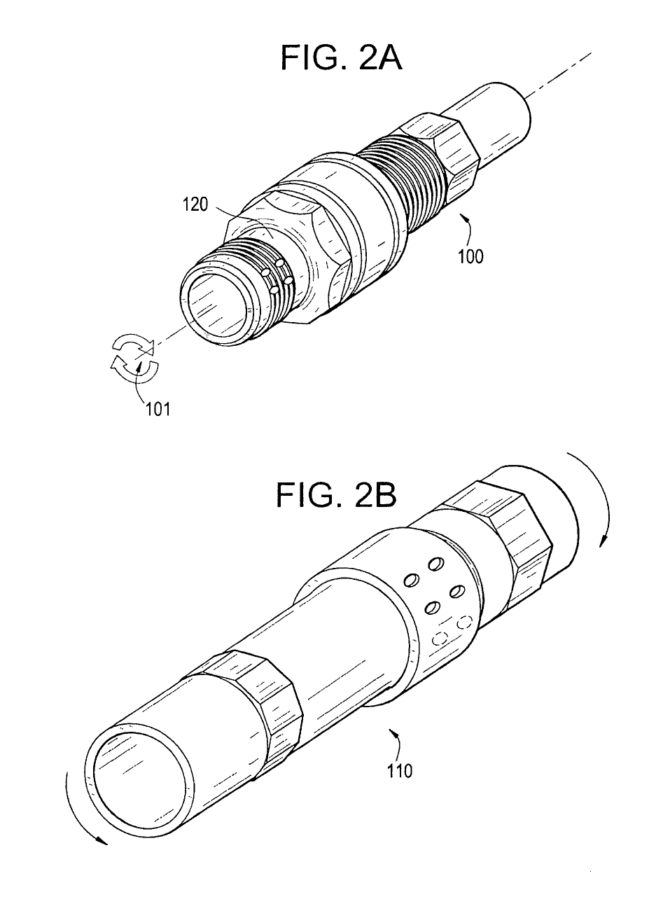

With reference to FIGS. 2A, 3 and 4, it is noted that the dilution airflow tuning part 80 may include a first dilution air-tune device 100 that is similar in shape to a spark plug. In an alternative embodiment of the invention, and with reference to FIG. 2B, it is noted that the dilution airflow tuning part 80 may include a second dilution air-tune device 110 that is similar in shape to a cross-fire tube.

In further-detail, as will be described with reference to the case of the first dilution air-tune device 100, the dilution air-porosity of the first dilution air-tune device 100 determines an available amount of dilution air present in the airflow 35. Therefore, since the dilution air-porosity of the first dilution air-tune device 100 may be increased and/or decreased, the available amount of the dilution air in the airflow 35 may also be increased and/or decreased. To this end, the first dilution air-tune device 100 may include a dilution airflow tuning component 120 that has a part (e.g., inner component 121) which may be rotated about an axis 101 thereof by, for example, an operator applying a wrench to appropriate sections of the first dilution air-tune device 100. This rotation increases and/or decreases the dilution air-porosity of the first dilution air-tune device 100 and thereby increases and/or decreases an available amount of the dilution air within the airflow 35.

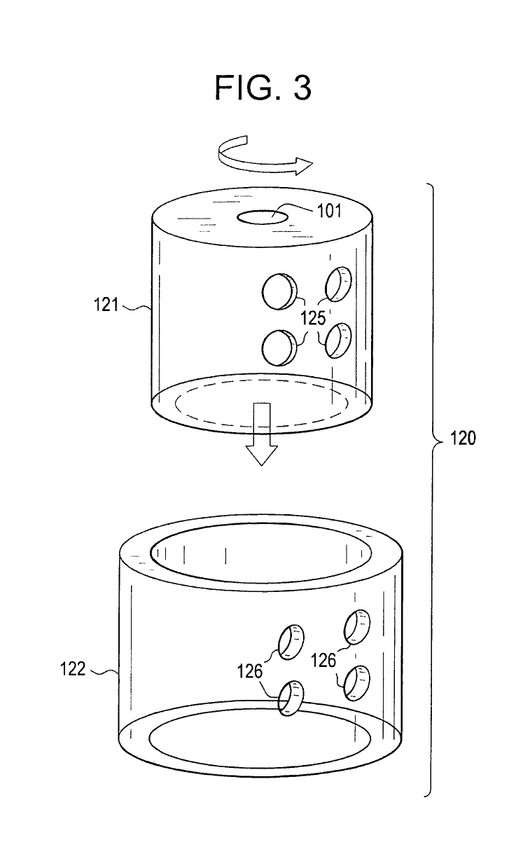

With further reference to FIG. 3, the dilution airflow tuning component 120 may include an inner component 121 having first bleed holes 125, which communicate with an exterior of the casing 40, and an outer component 122 having second bleed holes 126, which communicate with the airflow 35. Here, the outer component is coupled and stationary with respect to the first dilution air-tune device 100 while the inner component 121 may be rotated about the axis 101 and with respect to the outer component 122. Thus, the rotation of the inner component 121 brings the first and second bleed holes 125, 126 into positional agreement and/or disagreement with each other and thereby provides for an increased and/or decreased available amount of dilution air.

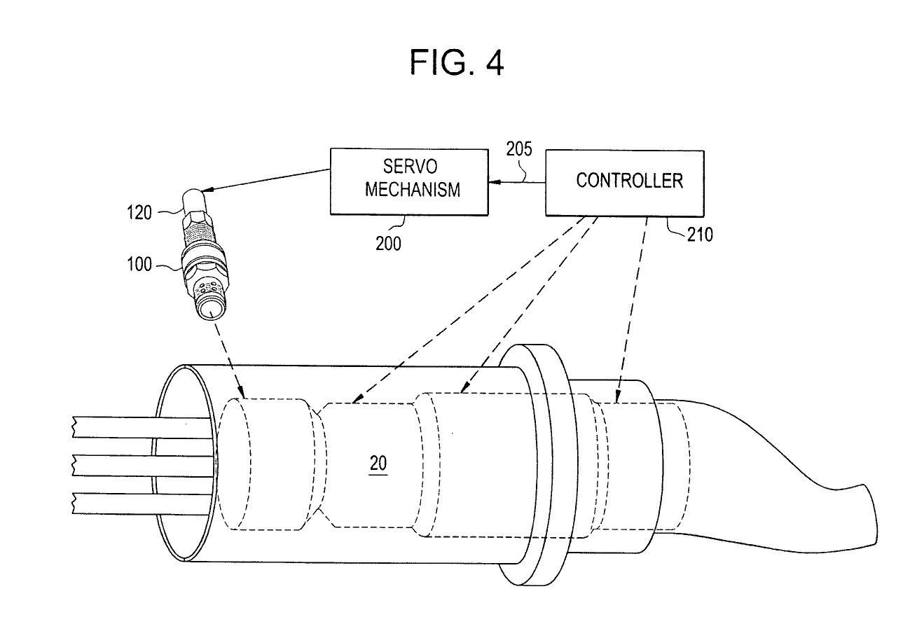

With reference now to FIG. 4, in a further embodiment of the invention, a servo mechanism 200 may be configured to manipulate the dilution airflow tuning component 120 of the first dilution air-tune device 100 so as to increase and/or decrease the dilution air-porosity thereof. Here, a controller 210 may be operably coupled to the combustion chamber 20 and to the servo mechanism 200. The controller 210 is configured to monitor the combustion in the combustion chamber 20 and to transmit a signal 205 to the servo mechanism 200 that instructs the servo mechanism to manipulate the dilution airflow tuning component 120.

In, accordance with another aspect of the invention, a method of retro-fitting, the combustor 10 of the gas turbine engine 1 is provided. As described above, the combustor 10 includes the combustion chamber 20, in which fuel combustion occurs, and the casing 40 circumferentially surrounding the combustion chamber 20 so as to define the airflow 35 between the casing 40 and the combustion chamber 20. The airflow 35 is configured to supply dilution air to the combustion chamber 20 via the dilution breach 24. The method includes measuring a fuel combustion characteristic within, e.g., the fuel combustion chamber, determining that an available amount of the dilution air to be supplied to the combustion chamber is below a predetermined threshold based on the measured fuel combustion characteristic, and installing a dilution airflow tuning part 80 onto the casing 40 and in communication with the airflow 35 so as to increase and/or decrease an available amount of the dilution air to be supplied to the combustion chamber 20.

Here, the method may further include determining a quantity of the available amount of the dilution air. Once the quantity of the available amount of the dilution air is determined, the dilution airflow tuning part 80 may be manipulated so as to increase aid/or decrease the available amount of the dilution air if the quantity of the available amount: of the dilution air is determined to be below the predetermined threshold. This predetermined threshold may be unique to each retro-fitted combustor 10 but, in general, will relate to an amount of dilution air that is sufficient to maintain an optimal level of combustion in the combustion chamber 20.

In accordance with yet another aspect of the invention, a method of building a combustor 10 of a gas turbine engine 1 is provided. The method includes forming a combustion chamber 20, forming a dilution breach 24 along an exterior of the combustion chamber 20, perimetrically surrounding the combustion chamber 20 with a casing 40 to define an airflow 35 between the casing 40 and the combustion chamber 20, the airflow 35 being configured to supply dilution air to the combustion chamber 20 via the dilution breach 24, and installing a dilution airflow tuning part 80 onto the casing 40 and in communication with the airflow 35 to thereby be positioned to increase and/or decrease an available amount of the dilution air to be supplied to the combustion chamber 20.

Here, the forming of the dilution breach 24 may include setting dimensions of the dilution breach 24 to initial values thereof while the installing of the dilution airflow tuning part 80 may include setting a dilution air-porosity of the dilution airflow tuning part 80 to an initial level, which is estimated to be in accordance with the initial values of the dimensions of the dilution breach 24. Then, as described above, a quantity of the available amount of the dilution air may be determined and the dilution airflow tuning part 80 may be manipulated to increase and/or decrease the available amount of the dilution air if the quantity is determined to be below the predetermined threshold.

In each of the above noted aspects of the invention, the provision of the dilution airflow tuning part 80 onto the casing 40 includes at least one of installing the dilution airflow tuning part 80 proximate to a cap assembly 50 and forward of the dilution breach 24, but not necessarily limited to this area, replacing a spark plug of the combustor with a first dilution air-tune device 100 that is similar in shape to a spark plug, replacing a cross-fire tube of the combustor with a second dilution air-tune device 110 that is similar in shape to a cross-fire tube, installing the dilution airflow tuning pail 80 onto the casing 40 at a position where no other components are already installed on the casing 40, or building a new casing with a boss disposed thereon to support the dilution airflow tuning part 80. Once so installed, the dilution air tuning part 80 may be manipulated to thereby increase and/or decrease the available amount of the dilution air.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor of a turbine comprising:
a combustion chamber, in which fuel combustion occurs and along which a dilution breach is defined;
a casing perimetrically surrounding the combustion chamber to define an airflow between the casing and the combustion chamber, the airflow being configured to supply dilution air to the combustion chamber via the dilution breach; and
a dilution airflow tuning part disposed on the casing and in communication with the airflow, the dilution airflow tuning part being configured to increase and/or decrease an available amount of the dilution air to be supplied to the combustion chamber.

2. The combustor according to claim 1, wherein the dilution airflow tuning part comprises a dilution air-tune device.

3. The combustor according to claim 2, wherein the dilution air-tune device has a shape of a spark plug.

4. The combustor according to claim 3, wherein the dilution air-tune device comprises:
a rotatable inner component having first bleed holes in communication with an exterior of the dilution air-tune device; and
an outer component having second bleed holes in communication with the airflow which positionally agree and/or disagree with the first bleed holes in accordance with the rotation of the inner component.

5. The combustor according to claim 4, wherein the positional agreement and/or disagreement increases and/or decreases the available amount of the dilution air to be supplied to the combustion chamber.

6. The combustor according to claim 3, wherein a dilution air-porosity of the dilution air-tune device is modified by manipulation of a dilution airflow tuning component installed therein to increase and/or decrease the available amount of the dilution air.

7. The combustor according to claim 6, wherein an operator manipulates the dilution airflow tuning component.

8. The combustor according to claim 6, further comprising:
a servo mechanism which is configured to manipulate the dilution airflow tuning component; and
a controller, operably coupled to the combustion chamber and to the servo mechanism, which is configured to monitor the fuel combustion and to transmit a signal to the servo mechanism to manipulate the dilution airflow tuning component.

9. The combustor according to claim 2, wherein the dilution air-tune device has a shape of a cross-fire tube.

10. A method of fitting a combustor of a turbine, including a fuel combustion chamber, and a casing perimetrically surrounding the combustion chamber and defining an airflow from which dilution air is supplied to the combustion chamber via a dilution breach, the method comprising:
measuring a fuel combustion characteristic;
determining that an available amount of the dilution air to be supplied to the combustion chamber is below a predetermined threshold based on the measured fuel combustion characteristic; and
installing a dilution airflow tuning part onto the casing and in communication with the airflow so as to increase and/or decrease an available amount of the dilution air to be supplied to the combustion chamber.

11. The method according to claim 10, further comprising determining a quantity of the available amount of the dilution air subsequent to the installing of the dilution airflow tuning part.

12. The method according to claim 11, further comprising manipulating the dilution airflow tuning part to modify the available amount of the dilution air if the quantity of the available amount of the dilution air is determined to be below a predetermined threshold.

13. The method according to claim 10, wherein the installing of the dilution airflow tuning part onto the casing comprises:
replacing a spark plug of the combustor with a dilution air-tune device.

14. The method according to claim 10, wherein the installing of the dilution airflow tuning part onto the casing comprises:
replacing a cross-fire tube of the combustor with a dilution air-tune device.

15. The method according to claim 10, wherein the installing of the dilution airflow tuning part onto the casing comprises:
initially installing a boss onto the casing to support the dilution airflow tuning part.

16. A method of providing a combustor of a turbine comprising:
forming a fuel combustion chamber;
forming a dilution breach along an exterior of the combustion chamber;
perimetrically surrounding the combustion chamber with a casing to define an airflow between the casing and the combustion chamber, the airflow being configured to supply dilution air to the combustion chamber via the dilution breach; and
installing a dilution airflow tuning part onto the casing and in communication with the airflow to thereby be positioned to increase and/or decrease an available amount of the dilution air to be supplied to the combustion chamber.

17. The method according to claim 16, wherein the forming of the dilution breach comprises setting dimensions of the dilution breach to initial values thereof, and
wherein the installing of the dilution airflow tuning part comprises setting a dilution air-porosity of the dilution airflow tuning part to an initial level in accordance with the initial values of the dimensions of the dilution breach.

18. The method according to claim 16, further comprising determining a quantity of the available amount of the dilution air.

19. The method according to claim 18, further comprising manipulating the dilution airflow tuning part to increase and/or decrease the available amount of the dilution air if the quantity is determined to be below a predetermined threshold.

20. The method according to claim 16, wherein the installing of the dilution airflow tuning part onto the casing comprises:
installing the dilution airflow tuning part onto a boss previously installed on the casing.
